(19) United States
(12) Patent Application Publication
(10) Pub. No.: US 2020/0105200 A1
(43) Pub. Date: Apr. 2, 2020

(54) OLED DISPLAYING METHOD AND DEVICE

(71) Applicant: Beijing Xiaomi Mobile Software Co., Ltd., Beijing (CN)

(72) Inventor: Jing GAO, Beijing (CN)

(73) Assignee: Beijing Xiaomi Mobile Software Co., Ltd.

(21) Appl. No.: 16/554,416

(22) Filed: Aug. 28, 2019

(30) Foreign Application Priority Data
Sep. 28, 2018 (CN) 201811141298.2

(51) Int. Cl. G09G 3/3258; G09G 3/3291

(52) U.S. Cl. CPC G09G 3/3258; G09G 2320/064; G09G 2320/0233; G09G 3/3291

(57) ABSTRACT

An OLED displaying method includes: acquiring a resistance value of a data line in an N^{th} row of an OLED displaying device; determining a duty ratio of an EM signal for the data line in the N^{th} row according to the resistance value of the data line in the N^{th} row, a preset resistance value, and a preset duty ratio of the EM signal; and outputting a control signal to the data line in the N^{th} row according to the duty ratio of the EM signal for the data line in the N^{th} row.

### CROSS-REFERENCE TO RELATED APPLICATIONS

This application is based on and claims priority of Chinese Patent Application No. 201811141298.2, filed on Sep. 28, 2018, which is incorporated herein by reference in its entirety.

### TECHNICAL FIELD

The present disclosure relates to the technical field of image display, and more particularly to an OLED displaying method and an OLED displaying device.

### BACKGROUND

An Organic Light-Emitting Diode (OLED) is a current driven component. A pixel circuit of the OLED may include a reset signal, a data signal, and an emission (EM) signal. The reset signal is used to reset to a low level, to avoid interference between frames. The data signal is used to charge a capacitor to control light emission of the OLED. The EM signal controls light emission of the OLED, with a low level indicating valid. That is, at a high level, the OLED does not emit light, and at a low level, the OLED emits light. Therefore, the brightness of the OLED can be controlled by adjusting a duty ratio of the EM signal.

### SUMMARY

According to a first aspect of the embodiments of the present disclosure, an OLED displaying method includes: acquiring a resistance value of a data line in an N^{th} row, wherein N is an integer greater than or equal to 1; determining a duty ratio of an EM signal for the data line in the N^{th} row according to the resistance value of the data line in the N^{th} row, a preset resistance value, and a preset duty ratio of the EM signal; and outputting a control signal to the data line in the N^{th} row according to the duty ratio of the EM signal for the data line in the N^{th} row.

According to a second aspect of the embodiments of the present disclosure, an OLED displaying device includes: a processor; and a memory for storing instructions executable by the processor, wherein the processor is configured to: acquire a resistance value of a data line in an N^{th} row, wherein N is an integer greater than or equal to 1; determine a duty ratio of an EM signal for the data line in the N^{th} row according to the resistance value of the data line in the N^{th} row, a preset resistance value, and a preset duty ratio of the EM signal; and output a control signal to the data line in the N^{th} row according to the duty ratio of the EM signal for the data line in the N^{th} row.

According to a third aspect of the embodiments of the present disclosure, a non-transitory computer readable storage medium has stored thereon a computer instruction that, when executed by a processor, causes the processor to perform an OLED displaying method, the method comprising: acquiring a resistance value of a data line in an N^{th} row, wherein N is an integer greater than or equal to 1; determining a duty ratio of an EM signal for the data line in the N^{th} row according to the resistance value of the data line in the N^{th} row, a preset resistance value, and a preset duty ratio of the EM signal; and outputting a control signal to the data line in the N^{th} row according to the duty ratio of the EM signal for the data line in the N^{th} row.

The technical solution provided by the embodiments of the present disclosure may include the following beneficial effects. A resistance value of a data line in an N^{th} row is acquired; a duty ratio of an EM signal for the data line in the N^{th} row is determined according to the resistance value of the data line in the N^{th} row, a preset resistance value, and a preset duty ratio of the EM signal; and a control signal is outputted to the data line in the N^{th} row according to the duty ratio of the EM signal for the data line in the N^{th} row. Thus, taking the preset resistance value and the preset duty ratio of the EM signal as reference, and based on the resistance value of the data line in each row, the duty ratio of the EM signal for the data line in each row is determined. Therefore, each row has a corresponding duty ratio of the EM signal, and when the signal of each row is controlled with the EM signal for each row of data line, the light emitting brightness of the OLED corresponding to each row of data line can be uniform, and it can effectively improve the brightness uniformity of the OLED displaying device.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram of a pixel circuit of an OLED displaying device according to an exemplary embodiment.

FIG. 2 is a schematic diagram of an operational timing diagram of a pixel circuit of an OLED displaying device according to an exemplary embodiment.

FIG. 3 is a flowchart of an OLED displaying method according to an exemplary embodiment.

FIG. 4 is a flowchart of step S102 in the OLED displaying method (FIG. 3) according to an exemplary embodiment.

FIG. 5 is a flowchart of an OLED displaying method according to another exemplary embodiment.

FIG. 6 is a schematic circuit diagram of an OLED displaying device according to an exemplary embodiment.

FIG. 7 is a block diagram of an OLED displaying device according to an exemplary embodiment.

FIG. 8 is a block diagram of a determining module in an OLED displaying device, according to an exemplary embodiment.

FIG. 9 is a block diagram of a first determining sub-module in an OLED displaying device, according to an exemplary embodiment.

FIG. 10 is a block diagram of an acquiring module in an OLED displaying device, according to an exemplary embodiment.

FIG. 11 is a block diagram of a first acquiring sub-module in an OLED displaying device, according to an exemplary embodiment.

FIG. 12 is a block diagram of an OLED displaying device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

FIG. 1 is a schematic diagram of a pixel circuit of an organic light emitting diode (OLED) display according to an exemplary embodiment. As shown in FIG. 1, the circuit includes: an OLED 10, thin film transistors T1-T6, and a storage capacitor C. The cathode of the OLED 10 is connected to a first end of T2. A gate electrode of T2 is connected to a gate electrode of T1. A gate electrode of T4, a first end of C, a first end of T5 and a first end of T6 are connected together. A second end of T4 is connected to a second end of T6. A first end of T4, a first end of T3 and a first end of T1 are connected together. A second end of T1 and a second end of C are connected together.

In the embodiment, T1, T2 and the OLED 10 constitute a basic OLED driving structure. T3-T6 may be respectively controlled to be in a turned-on state or a turned-off state under signals at their respective control terminals.

Further, in order to implement the function of the circuit, a bias voltage is applied to the circuit. Therefore, the circuit includes:

a first driving voltage line on which a positive working bias voltage EL_{VDD} is applied, the first driving voltage line being connected to the second end of T1; and a second driving voltage line on which a negative working bias voltage EL_{VSS} is applied, the second driving voltage line being connected to an anode of the OLED;

a data writing voltage line on which a data writing voltage signal V_{Data} (the data signal) is applied, the data writing voltage signal V_{Data} being for setting how the OLED in the circuit emits light, and the data writing voltage line being connected to a second end (which may be a source electrode) of T3; and

an initialization voltage line on which a constant initialization voltage signal Vᵢₙᵢₜᵢₐₗ is applied, the initialization voltage line being connected to a second end (which may be a source electrode) of T5.

Moreover, to control each thin film transistor to be turned on or turned off, three signal lines are employed to separately perform the control:

a writing switch signal line on which a writing switch signal voltage signal V_{Gate} is applied, the writing switch signal line being connected respectively to a gate electrode of T3 and a gate electrode of T6;

a reset switch signal line on which a reset switch signal voltage signal V_{Ref} (reset signal) is applied, the reset switch signal line being connected to a gate electrode of T5; and

a driving switch signal line on which a driving switch signal voltage signal V_{Emission} (the EM signal) is applied, the driving switch signal line being connected to the gate electrode of T1 and the gate electrode of T2.

In an embodiment, the potential zero points of all bias voltages are connected to a same common terminal, and the potential zero points of all signal voltages are also connected to a same common terminal.

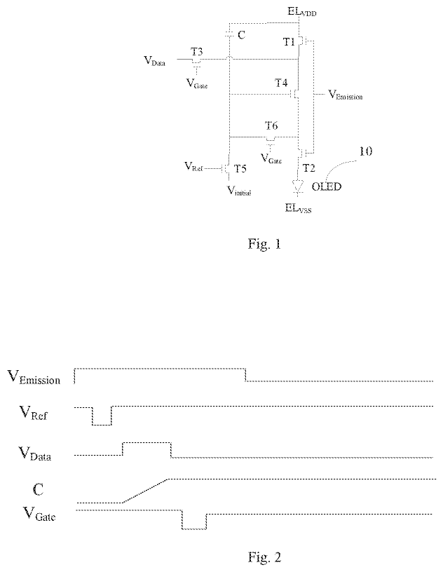

Referring to the working time sequence diagram of the circuit in FIG. 2, V_{Gate}, V_{Ref}, V_{Emission}, V_{Data}, and C respectively represent the writing switch signal, the reset switch signal, the driving switch signal, the data writing voltage line, and a capacitor discharge-charge signal.

In an embodiment, when V_{Ref} is at a low level and V_{Gate} is at a high level, the transistor T5 is turned on, and it is in a reset phase.

When V_{Ref} is at a high level, V_{Gate} is at a high level and V_{Data} is also at a high level, it is in a data writing phase, and the capacitor C is charged.

When V_{Ref} is at a high level and V_{Gate} is at a low level, it is in a light emitting phase, and at this time, C is discharged to cause the OLED to emit light.

It may be seen from the above, since the OLED is a current driven component, and since a resistance of the lines of the OLED display panel (“the panel”) may vary and a resistance of a distal end of the panel is greater than a resistance of a proximal end of the panel, such increase of the resistance on the lines of the panel causes the current on the lines of the panel to generate a voltage drop. Correspondingly, the current output to the OLED is decreased, so that the brightness uniformity of the OLED display panel may be poor sometimes.

In the present disclosure, a resistance value of a data line in an N^{th} row is acquired; a duty ratio of an EM signal for the data line in the N^{th} row is determined according to the resistance value of the data line in the N^{th} row, a preset resistance value, and a preset duty ratio of the EM signal; and finally, a control signal is outputted to the data line in the N^{th} row according to the duty ratio of the EM signal for the data line in the N^{th} row. Thus, taking the preset resistance value and the preset duty ratio of the EM signal as reference, and based on the resistance value of the data line in each row, the duty ratio of the EM signal for the data line in each row is determined. Therefore, each row has a corresponding duty ratio of the EM signal, and when the signal of each row is controlled with the EM signal for each row of data line, the light emitting brightness of the OLED corresponding to each row of data line can be more uniform, and it can effectively improve the brightness uniformity of the OLED display.

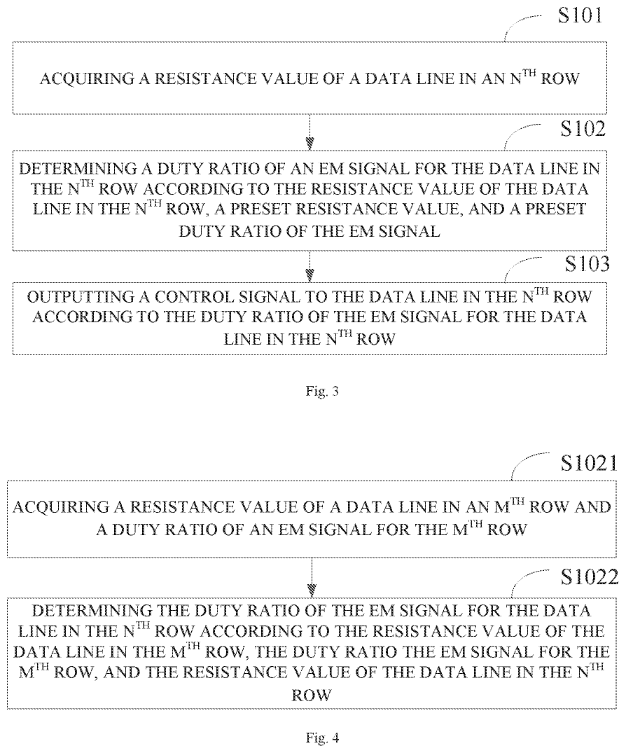

FIG. 3 is a flowchart of an OLED displaying method according to an exemplary embodiment. As shown in FIG. 3, the method includes the following steps S101-S103.

In step S101, a resistance value of a data line in an N^{th} row of an OLED display panel is acquired; where N is an integer greater than or equal to 1.

In step S102, a duty ratio of an EM signal for the data line in the N^{th} row is determined according to the resistance value of the data line in the N^{th} row, a preset resistance value, and a preset duty ratio of the EM signal.

In step S103, a control signal is outputted to the data line in the N^{th} row according to the duty ratio of the EM signal for the data line in the N^{th} row.

The lack of uniformity in the displaying process of the traditional OLED display panel is caused by the voltage drop on the lines, and the main voltage drop on the lines is caused by the resistances on the data line, in that a resistance away from the input end of the data line is larger than the resistance proximate to the input end of the data line. Due to such increase of the resistance on the data line, if the duty ratio of the EM signal on each row of data line is the same, the current of the OLED will decrease as the length of the data line increases, and will cause decrease of the brightness displayed by the OLED, thereby resulting lack of uniformity in the displaying process of the OLED display.

In the present disclosure, in order to make the brightness of the OLED display panel uniform during the displaying process, the EM signals of each row of the data lines are separately controlled. That is, the EM signals of each row of the data lines are independent, thereby effectively avoiding the problem of lack of uniformity in the displaying process of the OLED display panel caused by the variance in the resistance on the data line.

Since the EM signal of each row of the data line is independent, and the variance in the resistance of the data line cannot be changed, the EM signal of each row of the data line can be determined based on the resistance value of the data line, so as to avoid the influence of the variance in the resistance on the data line on the OLED current.

In the embodiment, a resistance value and an EM signal may be preset, and then the preset resistance value and a preset duty ratio of the EM signal are taken as reference, to determine the duty ratio of the EM signal of each row of the data line based on the resistance value of each row of the data line. Therefore, the duty ratio of the EM signal of each row of data line is based on the resistance value of the data line in that row.

In the present disclosure, a resistance value of a data line in an N^{th} row is acquired; a duty ratio of an EM signal for the data line in the N^{th} row is determined according to the resistance value of the data line in the N^{th} row, a preset resistance value, and a preset duty ratio of the EM signal; and finally, a control signal is outputted to the data line in the N^{th} row according to the duty ratio of the EM signal for the data line in the N^{th} row. Thus, taking the preset resistance value and the preset duty ratio of the EM signal as reference, and based on the resistance value of the data line in each row, the duty ratio of the EM signal for the data line in each row is determined. Therefore, each row has a corresponding duty ratio of the EM signal, and when the signal of each row is controlled with the EM signal for each row of data line, the light emitting brightness of the OLED corresponding to each row of data line can be more uniform, and it can effectively improve the brightness uniformity of the OLED display.

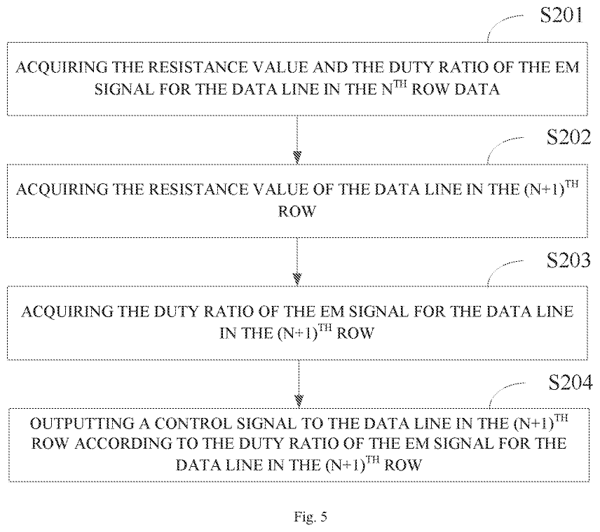

Since each OLED display panel has its own characteristics, when the preset resistance value and the preset duty ratio of the EM signal are employed, a display effect may not be optimal in some embodiments. To further improve the display effect, the above step S102 can be implemented as the following steps S1021-step S1022, as illustrated in FIG. 4.

In step S1021, a resistance value of a data line in an M^{th} row and a duty ratio of an EM signal for the M^{th} row are acquired; where M is an integer greater than or equal to 1, and M is different from N.

In step S1022, the duty ratio of the EM signal for the data line in the N^{th} row is determined according to the resistance value of the data line in the M^{th} row, the duty ratio of the EM signal in the M^{th} row, and the resistance value of the data line in the N^{th} row.

Of the rows of data lines in the OLED display, the resistance value of the data line in a certain row and the duty ratio of the EM signal for the certain row of the data line may be taken as the above preset resistance value and the preset duty ratio of the EM signal, and the resistance value and the EM signal for the data line in a different row may be adjusted based on the resistance value of the data line and the EM signal for the data line in the certain row.

Since the resistance value and the EM signal for the data line in a different row are adjusted based on the resistance value of the data line in a certain row and the duty ratio of the EM signal for the data line in the certain row of the OLED display, the adjusted resistance value and the EM signal for the data line in the different row may be more suitable for the OLED display. Therefore, it can improve the uniformity of the display effect of the OLED display.

In this embodiment, there is no limitation on which row is the M^{th} row, as long as the M^{th} row is different from the N^{th} row.

For example, the duty ratio of the EM signal for the data line in a different row may be determined according to the resistance value and the EM signal for the data line in the 4^{th} row. Or, the duty ratio of the EM signal for the data line in a different row may be determined according to the resistance value and the EM signal for the data line in the 1^{st} row.

For example, the duty ratio of the EM signal for the data line in the N^{th} row of may be determined according to the resistance value and the EM signal for the data line in the (N−1)^{th} row. In this case, N is an integer greater than or equal to 2, and M is (N−1).

For example, the duty ratio of the EM signal for the data line in the 2^{nd} row is determined according to the resistance value and the EM signal for the data line in the 1^{st} row; the duty ratio of the EM signal for the data line in the 3^{rd} row is determined according to the resistance value and the EM signal for the data line in the 2^{nd} row; and the duty ratio of the EM signal for the data line in the 4^{th} row is determined according to the resistance value and the EM signal for the data line in the 3^{rd} row, and so on so forth.

The technical solution provided by the embodiment of the present disclosure may include the following benefits. A resistance value of a data line in an M^{th} row and a duty ratio of an EM signal for the M^{th} row are acquired; the duty ratio of the EM signal for the data line in the N^{th} row is determined according to the resistance value of the data line in the M^{th} row, the EM signal in the M^{th} row, and the resistance value of the data line in the N^{th} row. In this way, the adjusted resistance value and the EM signal for the data line in a different row may be more suitable for the OLED display. Therefore, it can improve the uniformity of the display effect of the OLED display.

In one embodiment, determining the duty ratio of the EM signal for the data line in the N^{th} row according to the resistance value of the data line in the M^{th} row, the duty ratio of the EM signal in the M^{th} row, and the resistance value of the data line in the N^{th} row includes:

determining the duty ratio of the EM signal for the data line in the N^{th} row according to

$$EM ( N ) = \frac{R ( M )}{R ( N )} EM ( M ) .$$

Where, EM(N) represents the duty ratio of the EM signal for the data line in the N^{th} row. EM(M) represents the duty ratio of the EM signal for the data line in the M^{th} row, R(M) represents the resistance value of the data line in the M^{th} row, and R(N) represents the resistance value of the data line in the N^{th} row.

If the same OLED current is to be realized for the M^{th} row and the N^{th} row, it can be realized by compensating the EM signal. That is, the duty ratio of the EM signal for the data line in the N^{th} row may be determined according to the resistance value of the data line in the M^{th} row, the duty ratio of the EM signal for the M^{th} row, and the resistance value of the data line in the N^{th} row.

For example, according to the resistance value of the data line in the 2^{nd} row, the duty ratio of the EM signal for the 2^{nd} row, and the resistance value of the data line in the 3^{rd} row, determining the duty ratio of the EM signal for the data line in the 3^{rd} row may be:

determining the duty ratio of the EM signal for the data line in the 3^{rd} row according to

$$EM ( 3 ) = \frac{R ( 2 )}{R ( 3 )} EM ( 2 ) .$$

Where, EM(3) represents the duty ratio of the EM signal for the data line in the 3^{rd} row, EM(2) represents the duty ratio of the EM signal for the 2^{rd} row, R(3) represents of the data line in the 3^{rd} row, and R(2) represents the resistance value of the data line in the 2^{rd} row.

The technical solution provided by the embodiment of the present disclosure may include the following beneficial effects. The ratio duty of the EM signal for the data line in the N^{th} row is determined by taking the resistance value and the duty ratio of the EM signal for the data line in the M^{th} row as reference, and based on the resistance value of the data line in the N^{th} row. Therefore, the N^{th} row may have a corresponding duty ratio of the EM signal. When the signal of each row is controlled using an EM signal for each row of data line, the light emitting brightness of the corresponding OLED of each row of data line can be uniform, and it can effectively improve the brightness uniformity of the OLED display.

In one embodiment, acquiring the resistance value of the data line in the N^{th} row includes: acquiring the resistance value of the data line in the N^{th} row according to

$$R ( N ) = \frac{ρ * N * L}{s} + R ;$$

and acquiring the resistance value of the data line in the M^{th} row, including: acquiring the resistance value of the data line in the M^{th} row according to

$$R ( M ) = \frac{ρ * M * L}{s} + R .$$

Where R(N) represents the resistance value of the data line in the N^{th} row; R(M) represents the resistance value of the data line in the M^{th} row; ρ represents the resistivity of the data line; L represents the length of the data line of a single pixel; S represents the cross sectional area of the data line; and R represents the initial resistance value of the data line.

R represents the initial resistance value of the data line. R may have different values depending on the difference sizes and resolutions of the panels.

For calculating the resistance value of the present medium.

$$R = \frac{ρ * N * L}{S}$$

is usually employed, where R represents the resistance value of the present medium. S represents the cross sectional area of the present medium. L represents the length of the present medium, and ρ represents the resistivity of the present medium.

Based on the above formula,

$$R ( N ) = \frac{ρ * N * L}{S} + R$$

is employed in the present disclosure to acquire the resistance value of the data line in the N^{th} row, and

$$R ( M ) = \frac{ρ * M * L}{S} + R$$

is employed to acquire the resistance value of the data line in the M^{th} row.

The technical solution provided by the embodiment of the present disclosure may include the following beneficial effects. By acquiring the resistance value of the data line in the present row, the duty ratio of the EM signal is determined based on the resistance value of the data line in the present row. In this way, the light emitting brightness of the corresponding OLED of each row of data line can be uniform, and it can effectively improve the brightness uniformity of the OLED display.

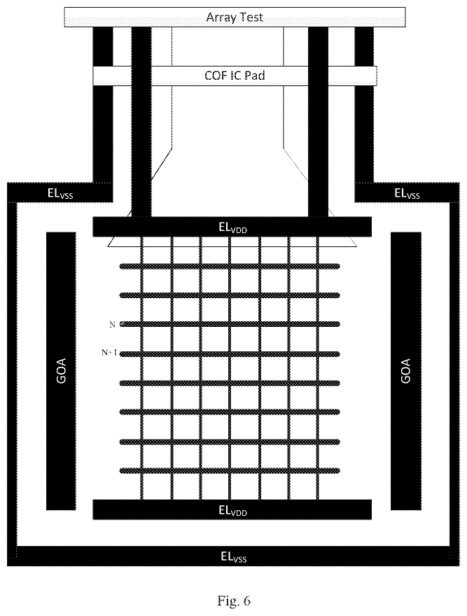

FIG. 5 is a flowchart of an OLED displaying method according to another exemplary embodiment. FIG. 6 is a circuit diagram of an OLED displaying device according to an exemplary embodiment, and components shown in FIG. 6 include an array test, a Chip On Film (COF) integrated circuit (IC) Pad, a gate on glass (GOA), in which EL_{VDD} represents a positive working bias voltage applied on the first driving voltage line described in the above embodiment, and EL_{VSS} represents a negative working bias voltage applied on the second driving voltage line described in the above embodiment. As shown in FIG. 5, the method includes the following steps S201-S204.

In step S201, the resistance value and the duty ratio of the EM signal for the data line in the N^{th} row data are acquired.

The resistance value of the data line in the N^{th} row is acquired according to

$$R ( N ) = \frac{ρ * N * L}{S} + R .$$

Where R(N) represents the resistance value of the data line in the N^{th} row; p represents the resistivity of the data line; L represents the length of the data line of a single pixel; S represents the cross sectional area of the data line, and R represents the initial resistance value of the data line.

In step S202, the resistance value of the data line in the (N+1)^{th} row is acquired.

The resistance value of the data line in the (N+1)^{th} row is acquired according to

$$R ( N + 1 ) = \frac{ρ * ( N + 1 ) * L}{S} + R .$$

Where R(N+1) represents the resistance value of the data line in the (N+1)^{th} row; ρ represents the resistivity of the data line; L represents the length of the data line of a single pixel; S represents the cross sectional area of the data line, and R represents the initial resistance value of the data line.

In step S203, the duty ratio of the EM signal for the data line in the (N+1)^{th} row is acquired.

The duty ratio EM(N+1) of the EM signal for the data line in the (N+1)^{th} row is acquired according to

$$EM ( N + 1 ) = \frac{R ( N )}{R ( N + 1 )} EM ( N ) .$$

Where EM(N) represents the duty ratio of the EM signal for the data line in the N^{th} row, EM(N+1) represents the duty ratio of the EM signal for the data line in the (N+1)^{th} row. R(N+1) represents the resistance value of the data line in the (N+1)^{th} row, and R(N) represents the resistance value of the data line in the N^{th} row.

In step S204, a control signal is outputted to the data line in the (N+1)^{th} row according to the duty ratio of the EM signal for the data line in the (N+1)^{th} row.

The following is a device embodiment of the present disclosure, which may be configured to implement the method embodiments of the present disclosure.

FIG. 7 is a block diagram of an OLED displaying device according to an exemplary embodiment. As shown in FIG. 7, the OLED displaying device includes:

an acquiring module 11 configured to acquire a resistance value of a data line in an N^{th} row, where N is an integer greater than or equal to 1;

a determining module 12 configured to determine a duty ratio of an EM signal for the data line in the N^{th} row according to the resistance value of the data line in the N^{th} row, which is acquired by the acquiring module 11, a preset resistance value, and a preset duty ratio of the EM signal; and

an outputting module 13 configured to output a control signal to the data line in the N^{th} row according to the duty ratio of the EM signal for the data line in the N^{th} row, which is determined by the determining module 13.

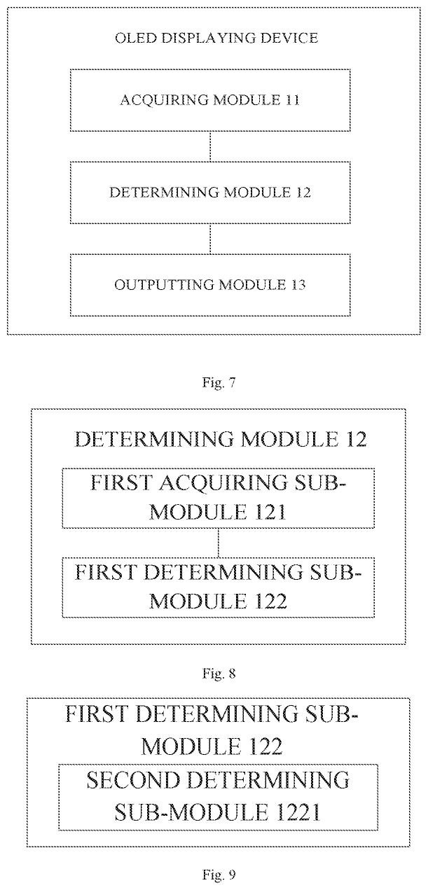

In an embodiment, as shown in FIG. 8, the determining module 12 includes: a first acquiring sub-module 121 and a first determining sub-module 122.

The first acquiring sub-module 121 is configured to acquire a resistance value of a data line in an M^{th} row and a duty ratio of an EM signal for the M^{th} row; where M is an integer greater than or equal to 1, and M is different from N.

The first determining sub-module 122 is configured to determine the duty ratio of the EM signal for the data line in the N^{th} row according to the resistance value of the data line in the M^{th} row, which is acquired by the first acquiring sub-module 121, the duty ratio of the EM signal for the M^{th} row, and the resistance value of the data line in the N^{th} row.

In an embodiment, as shown in FIG. 9, the first determining sub-module 122 includes a second determining sub-module 1221.

The second determining sub-module 1221 is configured to determine the duty ratio of the EM signal for the data line in the N^{th} row according to

$$EM ( N ) = \frac{R ( M )}{R ( N )} EM ( M ) ;$$

where EM(N) represents the duty ratio of the EM signal for the data line in the N^{th} row, EM(M) represents the duty ratio of the EM signal for the data line in the M^{th} row, R(M) represents the resistance value of the data line in the M^{th} row, and R(N) represents the resistance value of the data line in the N^{th} row.

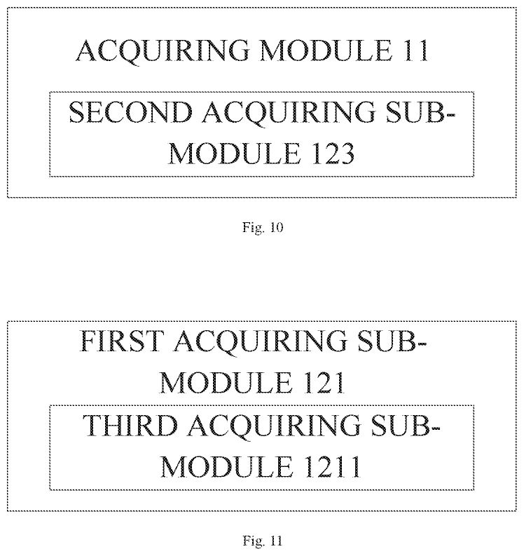

In an embodiment, as shown in FIG. 10, the acquiring module 11 includes: a second acquiring sub-module 123.

The second acquiring sub-module 123 is configured to acquire the resistance value of the data line in an N^{th} row according to

$$R ( N ) = \frac{ρ * N * L}{S} + R ,$$

where R(N) represents the resistance value of the data line in the N^{th} row; ρ represents a resistivity of the data line; L represents a length of the data line of a single pixel; S represents a cross sectional area of the data line; and R represents an initial resistance value of the data line.

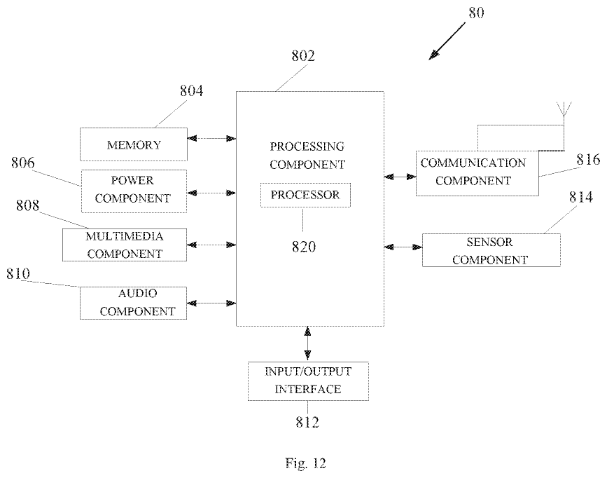

In an embodiment, as shown in FIG. 11, the first acquiring sub-module 121 includes a third acquiring sub-module 1211.

The third acquiring sub-module 1211 is configured to acquire a resistance value of a data line in an M^{th} row according to

$$R ( M ) = \frac{ρ * M * L}{S} + R ,$$

where R(M) represents the resistance value of the data line in the M^{th} row; ρ represents a resistivity of the data line; L represents a length of the data line of a single pixel; S represents a cross sectional area of the data line; and R represents an initial resistance value of the data line.

In exemplary embodiments, there is provided an OLED displaying device, including: a processor; and a memory for storing instructions executable by the processor, wherein the processor is configured to: acquire a resistance value of a data line in an N^{th} row, where N is an integer greater than or equal to 1; determine a duty ratio of an EM signal for the data line in the N^{th} row according to the resistance value of the data line in the Nm row, a preset resistance value, and a preset duty ratio of the EM signal; and output a control signal to the data line in the N^{th} row according to the duty ratio of the EM signal for the data line in the N^{th} row.

To determine a duty ratio of an EM signal for the data line in the N^{th} row according to the resistance value of the data line in the N^{th} row, a preset resistance value, and a preset duty ratio of the EM signal, the processor may be configured to: acquire a resistance value of a data line in an M^{th} row and a duty ratio of an EM signal for the M^{th} row; where M is an integer greater than or equal to 1, and M is different from N; and determine the duty ratio of the EM signal for the data line in the N^{th} row according to the resistance value of the data line in the M^{th} row, the duty ratio of the EM signal for the M^{th} row, and the resistance value of the data line in the N^{th} row.

In an embodiment, determining the duty ratio of the EM signal for the data line in the N^{th} row according to the resistance value of the data line in the M^{th} row, the duty ratio of the EM signal for the M^{th} row, and the resistance value of the data line in the N^{th} row, includes: determining the duty ratio of the EM signal for the data line in the N^{th} row according to

$$EM ( N ) = \frac{R ( M )}{R ( N )} EM ( M ) ;$$

where EM(N) represents the duty ratio of the EM signal for the data line in the N^{th} row. EM(M) represents the duty ratio of the EM signal for the data line in the M^{th} row, R(M) represents the resistance value of the data line in the M^{th} row, and R(N) represents the resistance value of the data line in the N^{th} row.

In an embodiment, acquiring a resistance value of a data line in an N^{th} row includes: acquiring the resistance value of the data line in an N^{th} row according to

$$R ( N ) = \frac{ρ * N * L}{S} + R ,$$

and acquiring a resistance value of a data line in an M^{th} row includes: acquiring a resistance value of a data line in an M^{th} row according to

$$R ( M ) = \frac{ρ * M * L}{S} + R ,$$

where R(N) represents the resistance value of the data line in the N^{th} row; R(M) represents the resistance value of the data line in the M^{th} row; ρ represents a resistivity of the data line; L represents a length of the data line of a single pixel; S represents a cross sectional area of the data line; and R represents an initial resistance value of the data line.

With regard to the device in the above embodiments, the specific manner in which the respective modules perform the operations has been described in detail in the embodiment relating to the method, and will not be repeated herein.

FIG. 12 is a block diagram of an OLED displaying device 80 according to an exemplary embodiment. For example, the device 80 may be applied to a terminal device.

The device 80 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 80, such as the operations associated with display, telephone calls, data communications, camera operations, and recording operations. The processing component 802 may include one or more processors 820 to execute instructions, to perform all or part of the steps of the above method. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the device 80. Examples of such data include instructions for any applications or methods operated on the device 80, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 80. The power component 806 may include a power management system, one or more power sources, and any other components associated with the generation, management, and distribution of power in the device 80.

The multimedia component 808 includes a screen providing an output interface between the device 80 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the device 80 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the device 80 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the device 80. For instance, the sensor component 814 may detect an open/closed status of the device 80, relative positioning of components, e.g., the display and the keypad, of the device 80, a change in position of the device 80 or a component of the device 80, a presence or absence of user contact with the device 80, an orientation or an acceleration/deceleration of the device 80, and a change in temperature of the device 80. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the device 80 and other devices. The device 80 can access a wireless network based on a communication standard, such as WiFi, 4G. or 5G. or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 80 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, to perform the above method.

In exemplary embodiments, there is also provided a non-transitory computer-readable storage medium including instructions, such as included in the memory 804, executable by the processor 820 in the device 80 to perform the above method. For example, the non-transitory computer-readable storage medium may be a ROM, a RAM, a CD-ROM, a magnetic tape, a floppy disc, an optical data storage device, and the like.

A non-transitory computer readable storage medium, when instructions in the storage medium are executed by the processor of the device 80, causes the device 80 to perform the OLED displaying method as described above. The method includes: acquiring a resistance value of a data line in an N^{th} row, where N is an integer greater than or equal to 1; determining a duty ratio of an emission EM signal for the data line in the N^{th} row according to the resistance value of the data line in the N^{th} row, a preset resistance value, and a preset duty ratio of the EM signal; and outputting a control signal to the data line in the N^{th} row according to the duty ratio of the EM signal for the data line in the N^{th} row.

Determining a duty ratio of an EM signal for the data line in the N^{th} row according to the resistance value of the data line in the N^{th} row, a preset resistance value, and a preset duty ratio of the EM signal, includes: acquiring a resistance value of a data line in an M^{th} row and a duty ratio of an EM signal for the M^{th} row; where M is an integer greater than or equal to 1, and M is different from N; and determining the duty ratio of the EM signal for the data line in the N^{th} row according to the resistance value of the data line in the M^{th} row, the duty ratio of the EM signal for the M^{th} row, and the resistance value of the data line in the N^{th} row.

Determining the duty ratio of the EM signal for the data line in the N^{th} row according to the resistance value of the data line in the M^{th} row, the duty ratio of the EM signal for the M^{th} row, and the resistance value of the data line in the N^{th} row, includes: determining the duty ratio of the EM signal for the data line in the N^{th} row according to

$$EM ( N ) = \frac{R ( M )}{R ( N )} EM ( M ) ;$$

where EM(N) represents the duty ratio of the EM signal for the data line in the N^{th} row, EM(M) represents the duty ratio of the EM signal for the data line in the M^{th} row, R(M) represents the resistance value of the data line in the M^{th} row, and R(N) represents the resistance value of the data line in the N^{th} row.

Acquiring a resistance value of a data line in an N^{th} row includes: acquiring the resistance value of the data line in an N^{th} row according to

$$R ( N ) = \frac{ρ * N * L}{S} + R ,$$

and acquiring a resistance value of a data line in an M^{th} row includes: acquiring a resistance value of a data line in an M^{th} row according to

$$R ( M ) = \frac{ρ * M * L}{S} + R ,$$

where R(N) represents the resistance value of the data line in the N^{th} row; R(M) represents the resistance value of the data line in the M^{th} row; ρ represents a resistivity of the data line; L represents a length of the data line of a single pixel; S represents a cross sectional area of the data line; and R represents an initial resistance value of the data line.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the disclosure only be limited by the appended claims.

1. An organic light-emitting diode (OLED) displaying method, comprising:
acquiring a resistance value of a data line in an N^{th} row of an OLED displaying device, wherein N is an integer greater than or equal to 1;
determining a duty ratio of an emission (EM) signal for the data line in the N^{th} row according to the resistance value of the data line in the N^{th} row, a preset resistance value, and a preset duty ratio of the EM signal; and
outputting a control signal to the data line in the N^{th} row according to the duty ratio of the EM signal for the data line in the N^{th} row.

2. The method according to claim 1, wherein determining a duty ratio of an EM signal for the data line in the N^{th} row according to the resistance value of the data line in the N^{th} row, a preset resistance value, and a preset duty ratio of the EM signal, comprises:
acquiring a resistance value of a data line in an M^{th} row of the OLED displaying device and a duty ratio of an EM signal for the M^{th} row, where M is an integer greater than or equal to 1, and M is different from N; and
determining the duty ratio of the EM signal for the data line in the N^{th} row according to the resistance value of the data line in the M^{th} row, the duty ratio of the EM signal for the M^{th} row, and the resistance value of the data line in the N^{th} row.

3. The method according to claim 2, wherein determining the duty ratio of the EM signal for the data line in the N^{th} row according to the resistance value of the data line in the M^{th} row, the duty ratio of the EM signal for the M^{th} row, and the resistance value of the data line in the N^{th} row, comprises:
determining the duty ratio of the EM signal for the data line in the N^{th} row according to
$$EM ( N ) = \frac{R ( M )}{R ( N )} EM ( M ) ;$$
wherein EM(N) represents the duty ratio of the EM signal for the data line in the N^{th} row, EM(M) represents the duty ratio of the EM signal for the data line in the M h row, R(M) represents the resistance value of the data line in the M^{th} row, and R(N) represents the resistance value of the data line in the N^{th} row.

4. The method according to claim 2, wherein acquiring a resistance value of a data line in an N^{th} row comprises:
acquiring the resistance value of the data line in the N^{th} row according to
$$R ( N ) = \frac{ρ * N * L}{S} + R ,$$
acquiring a resistance value of a data line in an M^{th} row comprises:
acquiring a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the Nm row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.

5. The method according to claim 3, wherein acquiring a resistance value of a data line in an N^{th} row comprises:
acquiring the resistance value of the data line in the N^{th} row according to
$$R ( N ) = \frac{ρ * N * L}{S} + R ,$$
and
acquiring a resistance value of a data line in an M^{th} row comprises:
acquiring a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the N^{th} row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.

6. An organic light-emitting diode (OLED) displaying device, comprising:
a processor; and
a memory for storing instructions executable by the processor,
wherein the processor is configured to:
acquire a resistance value of a data line in an N^{th} row of the OLED displaying device, wherein N is an integer greater than or equal to 1;
determine a duty ratio of an emission (EM) signal for the data line in the N^{th} row according to the resistance value of the data line in the N^{th} row, a preset resistance value, and a preset duty ratio of the EM signal; and
output a control signal to the data line in the N^{th} row according to the duty ratio of the EM signal for the data line in the N^{th} row.

7. The device according to claim 6, wherein in determining a duty ratio of an EM signal for the data line in the N^{th} row according to the resistance value of the data line in the N^{th} row, a preset resistance value, and a preset duty ratio of the EM signal, the processor is configured to:
acquire a resistance value of a data line in an M^{th} row of the OLED displaying device and a duty ratio of an EM signal for the M^{th} row, where M is an integer greater than or equal to 1, and M is different from N; and
determine the duty ratio of the EM signal for the data line in the N^{th} row according to the resistance value of the data line in the M^{th} row, the duty ratio of the EM signal for the M^{th} row, and the resistance value of the data line in the N^{th} row.

8. The device according to claim 7, wherein in determining the duty ratio of the EM signal for the data line in the N^{th} row according to the resistance value of the data line in the M^{th} row, the duty ratio of the EM signal for the M^{th} row, and the resistance value of the data line in the N^{th} row, the processor is configured to:
determine the duty ratio of the EM signal for the data line in the N^{th} row according to
$$EM ( N ) = \frac{R ( M )}{R ( N )} EM ( M ) ;$$
wherein EM(N) represents the duty ratio of the EM signal for the data line in the N^{th} row, EM(M) represents the duty ratio of the EM signal for the data line in the M^{th} row, R(M) represents the resistance value of the data line in the M^{th} row, and R(N) represents the resistance value of the data line in the N^{th} row.

9. The device according to claim 7, wherein in acquiring a resistance value of a data line in an N^{th} row, the processor is configured to:
acquire the resistance value of the data line in the N^{th} row according to
$$R ( N ) = \frac{ρ * N * L}{S} + R ,$$
and
in acquiring a resistance value of a data line in an M^{th} row, the processor is configured to:
acquire a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the N^{th} row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.

10. The device according to claim 8, wherein in acquiring a resistance value of a data line in an N^{th} row, the processor is configured to:
acquire the resistance value of the data line in the N^{th} row according to
$$R ( N ) = \frac{ρ * N * L}{S} + R ,$$
and
in acquiring a resistance value of a data line in an M^{th} row, the processor is configured to:
acquire a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the N^{th} row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.

11. A non-transitory computer readable storage medium having stored thereon a computer instruction that, when executed by a processor, causes the processor to perform an organic light-emitting diode (OLED) displaying method, the method comprising:
acquiring a resistance value of a data line in an N^{th} row, wherein N is an integer greater than or equal to 1;
determining a duty ratio of an emission (EM) signal for the data line in the N^{th} row according to the resistance value of the data line in the N^{th} row, a preset resistance value, and a preset duty ratio of the EM signal; and
outputting a control signal to the data line in the N^{th} row according to the duty ratio of the EM signal for the data line in the N^{th} row.

12. The non-transitory computer readable storage medium according to claim 11, wherein determining a duty ratio of an EM signal for the data line in the N^{th} row according to the resistance value of the data line in the N^{th} row, a preset resistance value, and a preset duty ratio of the EM signal, comprises:
acquiring a resistance value of a data line in an M^{th} row of the OLED displaying device and a duty ratio of an EM signal for the M^{th} row, where M is an integer greater than or equal to 1, and M is different from N; and
determining the duty ratio of the EM signal for the data line in the N^{th} row according to the resistance value of the data line in the M^{th} row, the duty ratio of the EM signal for the M^{th} row, and the resistance value of the data line in the N^{th} row.

13. The non-transitory computer readable storage medium according to claim 12, wherein determining the duty ratio of the EM signal for the data line in the N^{th} row according to the resistance value of the data line in the M^{th} row, the duty ratio of the EM signal for the M^{th} row, and the resistance value of the data line in the N^{th} row, comprises:
determining the duty ratio of the EM signal for the data line in the N^{th} row according to
$$EM ( N ) = \frac{R ( M )}{R ( N )} EM ( M ) ;$$
wherein EM(N) represents the duty ratio of the EM signal for the data line in the N^{th} row, EM(M) represents the duty ratio of the EM signal for the data line in the M^{th} row, R(M) represents the resistance value of the data line in the M^{th} row, and R(N) represents the resistance value of the data line in the N^{th} row.

14. The non-transitory computer readable storage medium according to claim 12, wherein acquiring a resistance value of a data line in an N^{th} row comprises:
acquiring the resistance value of the data line in the N^{th} row according to
$$R ( N ) = \frac{ρ * N * L}{S} + R ,$$
and
acquiring a resistance value of a data line in an M^{th} row comprises:
acquiring a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the N^{th} row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.

15. The non-transitory computer readable storage medium according to claim 13, wherein acquiring a resistance value of a data line in an N^{th} row comprises:
acquiring the resistance value of the data line in the N^{th} row according to
$$R ( N ) = \frac{ρ * N * L}{S} + R ,$$
and
acquiring a resistance value of a data line in an M^{th} row comprises:
acquiring a resistance value of the data line in the M^{th} row according to
$$R ( M ) = \frac{ρ * M * L}{S} + R ,$$
wherein R(N) represents the resistance value of the data line in the N^{th} row; R(M) represents the resistance value of the data line in the M^{th} row; ρ represents a resistivity of the data line in the N^{th} row or the M^{th} row; L represents a length of the data line in the N^{th} row or the M^{th} row; S represents a cross sectional area of the data line in the N^{th} row or the M^{th} row; and R represents an initial resistance value of the data line in the N^{th} row or the M^{th} row.
